(19) United States
(12) Patent Application Publication
(10) Pub. No.: US 2026/0370011 A1
(43) Pub. Date: Nov. 19, 2026

(54) BACKUP POWER SUPPLY SYSTEM

(71) Applicant: Panasonic Intellectual Property Management Co., Ltd., Osaka (JP)

(72) Inventors: YUTA NAGATOMI, Osaka (JP); TAKASHI KAWAI, Fukui (JP); TAKAAKI KATO, Hyogo (JP); YO KUMODA, Osaka (JP)

(21) Appl. No.: 19/153,792

(22) PCT Filed: Nov. 8, 2023
(86) PCT No.: PCT/JP2023/040234

§ 371 Date: Aug. 5, 2025

(30) Foreign Application Priority Data
Mar. 16, 2023 (JP) 2023-042360

(51) Int. Cl. H02J 7/14; B60R 16/033; H02J 1/08; H02J 7/00

(52) U.S. Cl. CPC H02J 7/14; H02J 1/086; H02J 7/865; B60R 16/033

(57) ABSTRACT

An electricity storage unit includes a cell assembly including n electricity storage cells connected in series to one another. A charging-discharging circuit is configured to charge the electricity storage unit with electric power supplied through a first power feed path connecting between a first port configured to be connected to a power supply and a second port configured to be connected to a first load, and to output electric power discharged from the electricity storage unit to the first power feed path. A first branch path is connected to a first output part of an m-th electricity storage cell of electricity storage cells where m is a positive integer less than or equal to n. A second branch path is connected to a second output part of a k-th electricity storage cell of electricity storage cells where k is a positive integer less than m. A voltage detector is configured to detect voltage values of voltages of the first branch path and the second branch path. A controller is configured to output a control signal to a switch unit based on a detection result of the voltage detector. The control signal instructs the switch unit which of the first branch path and the second branch path is to be connected to a second power feed path.

### TECHNICAL FIELD

The present disclosure relates to a backup power supply system. More particularly, the present disclosure relates to a backup power supply system capable of supplying electric power from an electricity storage unit to a load when a power supply fails.

### BACKGROUND ART

PTL 1 discloses a backup power supply system configured to supply electric power from an electric storage device to loads when a power supply fails. The loads to which electric power is to be supplied by the backup power supply system include a first load requiring high current and a second load having a higher minimum operable voltage than the first load. The backup power supply system includes a first voltage conversion circuit and a second voltage conversion circuit. The second voltage conversion circuit boosts (or steps down) the voltage from the power supply to charge the electric storage device. The first voltage conversion circuit steps down (or boosts) the voltage from the electric storage device to output a voltage higher than the minimum operable voltage of the second load. The backup power supply system further includes a first bypass path configured to supply electric power from the first voltage conversion circuit to the second load, and a second bypass path configured to supply electric power from the electric storage device to the first load without passing through the first voltage conversion circuit. A diode is connected between the second bypass path and the second load so that electric power can be supplied from the electric storage device through the second bypass path and the diode to the second load.

### CITATION LIST

### Patent Literature

PTL 1: International Publication No. 2021/235444

### SUMMARY

In the backup power supply system with the above-described configuration, the first load is directly connected to the electric storage device via the second bypass path. For this reason, the charge voltage of the electric storage device exceeds an upper limit voltage of the first load, a voltage is not supplied to the first load.

A backup power supply system in accordance with an aspect of the present disclosure includes a first power feed path, a third port, an electricity storage unit, a charging-discharging circuit, a second power feed path, a first branch path, a second branch path, a controller, a switch unit, and a voltage detector. The first power feed path connects a first port to a second port. The first port is configured to be connected to a power supply. The second port is configured to be connected to a first load. The third port is configured to be connected to a second load. The electricity storage unit includes a cell assembly including n electricity storage cells connected in series to one another where n is an integer greater than or equal to 3. The charging-discharging circuit is configured to charge the electricity storage unit with electric power supplied through the first power feed path and output electric power discharged from the electricity storage unit to the first power feed path. The second power feed path is connected to the third port. The first branch path is connected to a first output part being an output part of an m-th electricity storage cell out of the n electricity storage cells of the cell assembly where m is a positive integer less than or equal to n. The second branch path is connected to a second output part being an output part of a k-th electricity storage cell out of the n electricity storage cells of the cell assembly where k is a positive integer less than m. The first switch unit is configured to selectively connect one of the first branch path and the second branch path to the second power feed path. The voltage detector is configured to detect a voltage value of a voltage of the first branch path and a voltage value of a voltage of the second branch path. The controller is configured to output a control signal to the first switch unit based on a detection result of the voltage detector, the control signal instructing the first switch unit which one of the first branch path and the second branch path is connected to the second branch path.

According to the present disclosure, the voltage applied to a load is prevented from exceeding an upper limit voltage of the load.

### BRIEF DESCRIPTION OF THE DRAWINGS

FIG. 1 is a schematic block circuit diagram of a backup power supply system in accordance with an exemplary embodiment of the present disclosure.

FIG. 2 is a block circuit diagram of the backup power supply system of the embodiment for illustrating a circuit configuration thereof.

FIG. 3 is a schematic block circuit diagram of a backup power supply system in accordance with modified example 1 of the embodiment.

FIG. 4 is a specific block circuit diagram of the backup power supply system in accordance with modified example 1 of the embodiment.

FIG. 5 is a block circuit diagram of a backup power supply system in accordance with modified example 2 of the embodiment.

### DESCRIPTION OF EMBODIMENT

A backup power supply system according to an exemplary embodiment will be described below with reference to drawings. The structure described in the following exemplary embodiment is merely one embodiment of the present disclosure. The present disclosure is not limited to the following exemplary embodiment, but may be modified in various ways according to design or the like as far as such modifications provide advantageous effects according to the present disclosure.

### Exemplary Embodiment

### (1) Outline

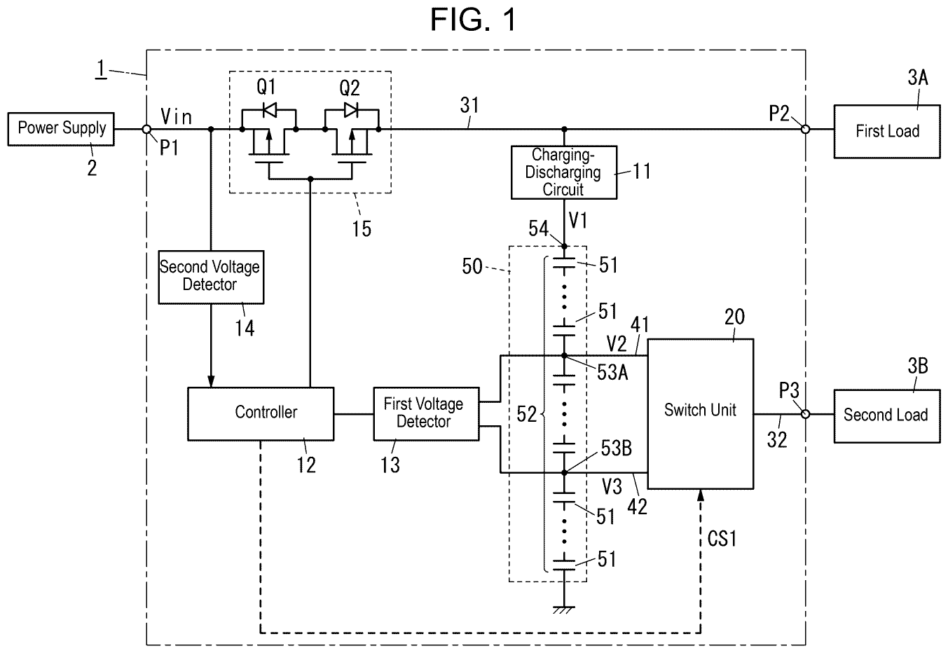

FIG. 1 is a schematic block circuit diagram of backup power supply system 1 in accordance with an exemplary embodiment. Backup power supply system 1 includes first power feed path 31, third port P3, electricity storage unit 50, charging-discharging circuit 11, second power feed path 32, first branch path 41, second branch path 42, controller 12, switch unit 20, and a voltage detector (first voltage detector 13).

First power feed path 31 connects first port P1 to second port P2. The first port P1 is configured to be connected to power supply 2. The second port P2 is configured to be connected to first load 3A.

Third port P3 is configured to be connected to second load 3B.

Electricity storage unit 50 includes cell assembly 52 including n electricity storage cells 51 connected in series to one another where n is an integer greater than or equal to 3.

Charging-discharging circuit 11 is configured to charge electricity storage unit 50 with the electric power supplied from first power feed path 31, and to output the electric power discharged from electricity storage unit 50 to first power feed path 31.

Second power feed path 32 is connected to third port P3.

First branch path 41 is connected to first output part 53A which is an output part of the m-th electricity storage cell out of electricity storage cells 51 of cell assembly 52, where m is a positive integer less than or equal to n.

Second branch path 42 is connected to second output part 53B which is an output part of the k-th electricity storage cell out of electricity storage cells 51 of cell assembly 52, where k is a positive integer less than m.

Switch unit 20 is configured to selectively connect one of first branch path 41 and second branch path 42 to second power feed path 32 according to control signal CS1 input from controller 12.

The voltage detector (first voltage detector 13) is configured to detect a voltage value of voltage V2 of first branch path 41 and a voltage value of voltage V3 of second branch path 42.

Based on the detection result of voltage detector (first voltage detector 13), controller 12 is configured to output, to switch unit 20, control signal CS1 that instructs which of first branch path 41 and second branch path 42 is to be connected to second power feed path.

Backup power supply system 1 in accordance with the embodiment may be installed to, for example, an automobile. Power supply 2 to be connected to first port P1 is, for example, an automobile battery. First load 3A and second load 3B are electrical devices that are installed to the automobile. Second load 3B to be connected to first output part 53A or second output part 53B of electricity storage unit 50 is an electrical device constantly requiring supply of electric power. The device may include a load, such as an electric brake system and a shift-by-wire system, requiring large current. Second load 3B is not limited to a single electrical device, but may include plural electrical devices. First load 3A may include, for example, an advanced driver assistance systems (ADAS), or a control system configured to control, e.g., an electric brake system and a shift-by-wire system. First load 3A is not limited to a single electrical device, but may include plural electrical devices.

First port P1, second port P2, and third port P3 may be components (terminals) for connecting, e.g., electric wires, but may be, for example, leads of electronic components, or portions of electrical conductor formed as wiring on a circuit board. The phrase “connecting” two elements means that the two elements are electrically connected to each other in which other elements may be interposed between the two elements.

In cell assembly 52, the m-th electricity storage cell out of the n electricity storage cells is arranged at the m-th order counted from an electricity storage cell 51 out of the electricity storage cells 51 which is connected to the ground. The m-th electricity storage cell includes a first end and a second end. The output port of the m-th electricity storage cell is the first end with a higher potential than the second end. Similarly, the k-th electricity storage cell out of the n electricity storage cells is arranged at the k-th order counted from an electricity storage cell 51 out of the electricity storage cells 51 which is connected to the ground. The k-th electricity storage cell includes a first end and a second end. The output port of the k-th electricity storage cell is the first end with a higher potential than the second end.

Backup power supply system 1 in accordance with the embodiment is configured to supply electric power from charging-discharging circuit 11 to first load 3A via first power feed path 31. In addition, backup power supply system 1 is configured to supply electric power to second load 3B from first output part 53A of electricity storage unit 50 via first branch path 41, switch unit 20, and second power feed path 32, or from second output part 53B of electricity storage unit 50 via second branch path 42, switch unit 20, and second power feed path 32. This configuration allows backup power supply system 1 to reduce the possibility of supplying electric power to the loads that do not require supply of electric power, and to reduce electric power loss. As electric power is supplied from electricity storage unit 50 to second load 3B, the voltage values of voltage V2 of first branch path 41 and voltage V3 of second branch path 42 decrease. However, controller 12 is configured to connect first branch path 41 or second branch path 42 to second power feed path 32 according to the detection result of the voltage detector (first voltage detector 13), thereby allowing electric power to be supplied without causing the voltage applied to second load 3B to fall below a minimum operable voltage of second load 3B. The minimum operable voltage of second load 3B means a lower limit value of an operable voltage activating second load 3B, or a lower limit value of the operable voltage with a predetermined margin voltage added thereto.

### (2) Details

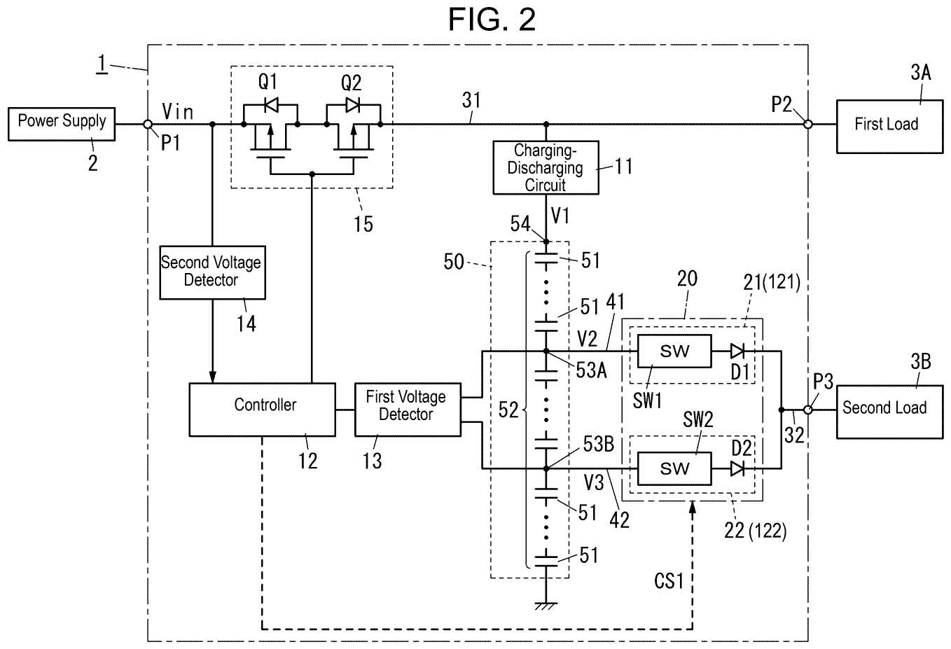

Backup power supply system 1 according to the embodiment will be detailed below with reference to FIGS. 1 and 2.

### (2.1) Configuration

Backup power supply system 1 according to the embodiment is configured to be installed to, for example, an automobile, and to supply electric power to first load 3A and second load 3B installed to the automobile. Backup power supply system 1 is configured to supply electric power from electricity storage unit 50 to first load 3A and second load 3B in a failure state in which power supply 2 (for example, an automobile battery) of the automobile has failure. This configuration allows first load 3A and second load 3B to continuously operate with the electric power supplied from electricity storage unit 50 even when power supply 2 has a failure. In a non-failure state in which power supply 2 has not failure, electric power is supplied from power supply 2 to first load 3A via first power feed path 31. In a non-failure state of power supply 2, electric power is supplied from power supply 2 to second load 3B via a power feed path separately provided in the automobile.

The phrase “failure state of power supply 2” refers to a state in which voltage Vin is input from power supply 2 to first port P1 decreases to a voltage lower than a predetermined threshold value due to, for example, a failure of power supply 2, a ground fault of power supply 2 or a circuit connecting power supply 2 and first port P1. The phrase “non-failure state of power supply 2” refers to a state in which voltage Vin that is input from power supply 2 to first port P1 is higher than or equal to the threshold value. The threshold value is preferably set to a voltage that is lower than the rated voltage of power supply 2 and higher than the minimum operable voltage required for first load 3A and second load 3B to operate properly.

As described above, backup power supply system 1 includes first power feed path 31, third port P3, electricity storage unit 50, charging-discharging circuit 11, second power feed path 32, first branch path 41, second branch path 42, controller 12, switch unit 20, and a voltage detector (first voltage detector 13). Backup power supply system 1 further includes second voltage detector 14 and main switch 15.

Backup power supply system 1 includes first port P1, second port P2, and third port P3.

First port P1 is configured to be connected to power supply 2 which is a direct-current power supply. Power supply 2 may be, for example, an automobile battery.

Second port P2 is configured to be connected to first load 3A. First load 3A may include a load with the lower limit value of operable voltage being high, for example, a control system, such as ADAS or a load to which supply of electric power may be stopped in the middle of backup (for example, a door unlock system).

Third port P3 is configured to be connected to second load 3B. Second load 3B may include a load, such as an electric brake system, that constantly requires the backup and also has a lower limit value of operable voltage that is lower than that of first load 3A.

First power feed path 31 connects first port P1 to second port P2. That is, first power feed path 31 is connected to first port P1 and second port P2 in between first port P1 and second port P2, and is directly connected to first port P1 and second port P2 in accordance with the embodiment. In accordance with the embodiment, main switch 15 is connected in first power feed path 31 connecting first port P1 to second port P2. More specifically, main switch 15 is connected to an electrical path between first port P1 and a node in first power feed path 31 at which charging-discharging circuit 11 is connected to first power feed path 31.

Main switch 15 is switched to a connected state or a disconnected state, according to a control signal that is input from controller 12. In the connected state, electric current flows in both directions. In the disconnected state, electric current of both directions is interrupted.

Main switch 15 includes, for example, two field effect transistors Q1 and Q2 that are connected in series to each other between first port P1 and second port P2. The two field effect transistors Q1 and Q2 may be, for example, P-channel metal-oxide semiconductor Field-Effect Transistors (MOSFETs). The source of field effect transistor Q1 is connected to first port P1. The source of field effect transistor Q2 is connected to second port P2. The drains of field effect transistors Q1 and Q2 are electrically connected to each other, and the gates of field effect transistors Q1 and Q2 are electrically connected to each other. Field effect transistors Q1 and Q2 are controlled to be turned on and off according to a control signal that is input from controller 12 to the gates of the transistors. When both field effect transistors Q1 and Q2 are turned on, main switch 15 is in the connected state that allows electric current to flow in both directions. When both field effect transistors Q1 and Q2 are turned off, main switch 15 is in the disconnected state that interrupts electric current in both directions.

Electricity storage unit 50 includes cell assembly 52 including n electricity storage cells 51 connected in series to one another. Each of n electricity storage cells 51 includes, for example, an electrical double layer capacitor (EDLC) capable of rapid charging and discharging. Each of the n electricity storage cells 51 may be a single cell, or may include plural cells connected in parallel with one another.

Electricity storage unit 50 includes all-cell output part 54 which is the output part of the n-th electricity storage cell 51, first output part 53A which is the output part of the m-th electricity storage cell 51, and second output part 53B which is the output part of the k-th electricity storage cell 51. All-cell output part 54 is the first end, having a higher potential, of the first and second ends of cell assembly 52 including n electricity storage cells 51.

Charging-discharging circuit 11 includes, for example, a bidirectional DC-DC converter configured to boost and step-down operations. Charging-discharging circuit 11 is configured to operate either in a charge mode for boosting voltage Vin input from power supply 2 to charge electricity storage unit 50, or in a discharge mode for stepping down or boosting voltage V2 output from electricity storage unit 50 to output the voltage to first power feed path 31. Charging-discharging circuit 11 is configured to operate in the charge mode when power supply 2 is not in a failure state so that the voltage input from power supply 2 via first power feed path 31 is boosted to charge electricity storage unit 50. Charging-discharging circuit 11 operates in the discharge mode when power supply 2 is in a failure state to step down or boost voltage V1 output from all-cell output part 54 of electricity storage unit 50 to output the voltage to first power feed path 31. When voltage V1 that is output from all-cell output part 54 of electricity storage unit 50 is higher than the upper limit value of the operable voltage of first load 3A, charging-discharging circuit 11 steps down voltage V1 output from all-cell output part 54 and output the stepped-down voltage to first power feed path 31. On the other hand, when voltage V1 output from all-cell output part 54 of electricity storage unit 50 is lower than the minimum operable voltage of first load 3A, charging-discharging circuit 11 boosts voltage V1 and output the boosted voltage to first power feed path 31. Charging-discharging circuit 11 may step down or boost voltage V1 output from all-cell output part 54 of electricity storage unit 50 to output the voltage to first power feed path 31 even in a non-failure state, so that electric power from both power supply 2 and electricity storage unit 50 is supplied to first load 3A.

First voltage detector 13 as the voltage detector is configured to detect the voltage values of voltage V2 output from first output part 53A of electricity storage unit 50 (i.e., voltage V2 of first branch path 41) and voltage V3 output from second output part 53B (i.e., voltage V3 of second branch path 42). First voltage detector 13 is configured to output the detection results of the voltage values of voltages V2 and V3 to controller 12.

Second voltage detector 14 is configured to detect the voltage value of Voltage Vin input from power supply 2 to first port P1, and to output the detection result of the voltage value of Voltage Vin to controller 12.

Switch unit 20 is configured to selectively connect one of first branch path 41 and second branch path 42 to second power feed path 32 according to control signal CS1 input from controller 12.

FIG. 2 shows an example of a specific circuit of switch unit 20. Switch unit 20 includes first switch circuit 21 connected between third port P3 and first branch path 41, and second switch circuit 22 connected between third port P3 and second branch path 42. First switch circuit 21 is connected to third port P3 and first branch path 41 between third port P3 and first branch path 41. In accordance with the embodiment, the first switch circuit 21 is directly connected to third port P3 and first branch path 41. Second switch circuit 22 is connected to third port P3 and second branch path 42 between third port P3 and second branch path 42. In accordance with the embodiment, second switch circuit 22 is directly connected to third port P3 and second branch path 42. First switch circuit 21 is connected between third port P3 and first branch path 41, and includes series circuit 121 including first switch SW1 and first diode D1. Specifically, series circuit 121 is connected to third port P3 and first branch path 41 between third port P3 and first branch path 41. In accordance with the embodiment, series circuit 121 is directly connected to third port P3 and first branch path 41. In series circuit 121, first switch SW1 and first diode D1 are connected in series to each other. Second switch circuit 22 is connected between third port P3 and second branch path 42, and includes series circuit 122 including second switch SW2 and second diode D2. Specifically, series circuit 122 is connected to third port P3 and second branch path 42 between third port P3 and second branch path 42. In accordance with the embodiment, series circuit 122 is directly connected to third port P3 and second branch path 42. In series circuit 122, second switch SW2 and second diode D2 are connected in series to each other. In other words, switch unit 20 includes series circuit 121 including first switch SW1 and first diode D1, and series circuit 122 including second switch SW2 and second diode D2. Series circuit 121 including first switch SW1 and first diode D1 is connected between third port P3 and first branch path 41. Series circuit 122 including second switch SW2 and second diode D2 is connected between third port P3 and second branch path 42.

First switch SW1 and second switch SW2 are implemented by semiconductor switches, such as MOSFETs. First switch SW1 and second switch SW2 are controlled to be turned on and off according to control signal CS1 input from controller 12. First switch SW1 and second switch SW2 are not limited to MOSFETs, but may be semiconductor switches, such as insulated gate bipolar transistors IGBTs) or mechanical contactors, such as relays.

A first end of first switch SW1 is connected to first output part 53A of electricity storage unit 50. A second end of first switch SW1 is connected to the anode of first diode D1. The cathode of first diode D1 is connected to third port P3. Thus, first diode D1 allows electric current to flow from first output part 53A toward third port P3, and prevents electric current from flowing from third port P3 toward first output part 53A.

A first end of second switch SW2 is connected to second output part 53B of electricity storage unit 50. A second end of second switch SW2 is connected to the anode of second diode D2. The cathode of second diode D2 is connected to third port P3. Thus, second diode D2 allows electric current to flow from second output part 53B toward third port P3, and prevents electric current from flowing from third port P3 toward second output part 53B.

Controller 12 is implemented by, for example, a microcomputer including a processor and a memory. In other words, controller 12 is implemented by a computer system including a processor and a memory. The processor is configured to execute appropriate programs to allow the computer system to function as controller 12. The programs may be previously stored in the memory or may be recorded and provided in non-volatile recording media, such as a memory card, via a telecommunication line, such as the Internet. Controller 12 is not necessarily implemented by a computer system, but may be implemented by analog circuits or gate drive circuits.

Controller 12 is configured to compare the detection result of the voltage value of voltage Vin input from second voltage detector 14 with a predetermined threshold value, thereby determining whether power supply 2 is in the failure state or not. Controller 12 controls main switch 15 to allow main switch 15 to be in the connected state or the disconnected state according to the result of determination of whether power supply 2 is in the failure state or not. Specifically, when the voltage value of voltage Vin is higher than or equal to the threshold value, controller 12 determines that power supply 2 is in a non-failure state, and turns on MOSFETs Q1 and Q2 to cause main switch 15 to be in the connected state. On the other hand, when the voltage value of voltage Vin is lower than the threshold value, controller 12 determines that power supply 2 is in the failure state, and turns off MOSFETs Q1 and Q2 to cause main switch 15 to be the disconnected state.

In addition, based on the detection result of first voltage detector 13, controller 12 outputs, to switch unit 20, control signal CS1 that instructs which one of first branch path 41 and second branch path 42 is to be connected to second power feed path 32.

For example, when voltage V3 of second branch path 42 is higher than or equal to the minimum operable voltage of second load 3B, controller 12 outputs, to switch unit 20, control signal CS1 that instructs switch unit 20 to connect second branch path 42 to second power feed path 32. Specifically, controller 12 outputs, to switch unit 20, control signal CS1 that instructs switch unit 20 to turn off first switch SW1 off and urn on second switch SW2. At this moment, first switch SW1 is turned off and second switch SW2 is turned on, so that electric power is supplied from second output part 53B of the k-th electricity storage cell 51 to second load 3B via second branch path 42, switch unit 20, and third power feed path 32.

On the other hand, when voltage V3 of second branch path 42 reaches lower than the minimum operable voltage of second load 3B (the lower limit value of the operable voltage, or the lower limit value of the operable voltage with a predetermined margin voltage added thereto), controller 12 outputs, to switch unit 20, control signal CS1 that instructs switch unit 20 to connect first branch path 41 to second power feed path 32.

Specifically, controller 12 outputs, to switch unit 20, control signal CS1 that instructs switch unit 20 to turn on first switch SW1 while second switch SW2 is continuously turned on and then, to subsequently turn off second switch SW2. At this moment, first switch SW1 is turned off and second switch SW2 is turned on, so that electric power is supplied from second output part 53B of the m-th electricity storage cell 51 to second load 3B via second branch path 41, switch unit 20, and second power feed path 32. In the state where both first switch SW1 and second switch SW2 are turned on, second diode D2 prevents electric power from flowing back from first output part 53A of the m-th electricity storage cell 51 to second output part 53B of the k-th electricity storage cell 51.

### (2.2) Description of Operation

An operations of backup power supply system 1 according to the embodiment will be described below.

In a non-failure state in which power supply 2 does not have a failure, voltage Vin higher than or equal to a threshold value is input from power supply 2 to first port P1. At this moment, controller 12 determines that power supply 2 is in the non-failure state based on the detection result of second voltage detector 14, and turns on MOSFETs Q1 and Q2 to bring main switch 15 into a connected state. When main switch 15 is brought into the connected state, voltage Vin input from power supply 2 to first port P1 is output from second port P2 to first load 3A, and first load 3A operates with the electric power supplied from power supply 2. In addition, when power supply 2 is in the non-failure state, electric power is supplied from power supply 2 to second load 3B via a power feed path provided outside of backup power supply system 1. Controller 12 causes charging-discharging circuit 11 to operate in a charge mode, and charging-discharging circuit 11 boosts voltage Vin input from power supply 2 to first power feed path 31 to charge electricity storage unit 50, and electricity storage unit 50 is charged to a voltage higher than voltage Vin of power supply 2. When the number of electricity storage cells 51 that constitute electricity storage unit 50 is small, the voltage of electricity storage unit 50 may be lower than or equal to voltage Vin of power supply 2.

On the other hand, when power supply 2 turns to a failure state, voltage Vin input from power supply 2 to first port P1 becomes lower than the threshold value. At this moment, controller 12 determines that power supply 2 is in the failure state based on the detection result of second voltage detector 14, and turns off MOSFETs Q1 and Q2 to bring main switch 15 into a non-connected state.

In the failure state, controller 12 causes charging-discharging circuit 11 to operate in the discharge mode, and charging-discharging circuit 11 steps down or boosts voltage V1 output from all-cell output part 54 of electricity storage unit 50 to supply the stepped-down or boosted voltage to first load 3A.

In addition, in the failure state, controller 12 controls switch unit 20 based on the detection result of first voltage detector 13 to connect one of first branch path 41 and second branch path 42 to second load 3B.

For example, when voltage V3 of second branch path 42 is higher than or equal to the minimum operable voltage of second load 3B, controller 12 outputs, to switch unit 20, control signal CS1 that turns off first switch SW1 and turn on second switch SW2. At this moment, first switch SW1 is turned off and second switch SW2 is turned on, so that electric power is supplied from second output part 53B of the k-th electricity storage cell 51 to second load 3B via second branch path 42, second switch SW2, second diode D2, and second power feed path 32.

When electric power is supplied from second output part 53B of electricity storage unit 50 to second load 3B, voltage V3 of second branch path 42 gradually decreases. Then, when voltage V3 of second branch path 42 reaches a voltage lower than the minimum operable voltage of second load 3B (the lower limit value of the operable voltage or the lower limit value of the operable voltage with a predetermined margin voltage added thereto), controller 12 outputs, to switch unit 20, control signal CS1 that instructs switch unit 20 so as to turn on first switch SW1 while second switch SW2 is continuously turned on and to subsequently turn off second branch path 42. At this moment, first switch SW1 is turned on and second switch SW2 is turned off, so that electric power is supplied from first output part 53A of the m-th electricity storage cell 51 to second load 3B via first branch path 41, first switch SW1, first diode D1, and second power feed path 32.

Thus, in the failure state, electric power is supplied from electricity storage unit 50 to first load 3A and second load 3B, so that first load 3A and second load 3B operate. When voltage V2 of second branch path 42 is higher than or equal to the minimum operable voltage of second load 3B, second branch path 42 is connected to second power feed path 32, so that electric power is supplied from second output part 53B to second load 3B. This configuration prevents voltage higher than necessary from being output to second load 3B, thereby reducing electric power loss. In addition, when voltage V2 of second branch path 42 becomes lower than the minimum operable voltage of second load 3B, first branch path 41 is connected to second power feed path 32, so that electric power is supplied from first output part 53A to second load 3B. This configuration allows second load 3B to receive a voltage higher than or equal to the minimum operable voltage. As a result, even in the failure state of power supply 2, a voltage higher than or equal to the minimum operable voltage is supplied to second load 3B to activate second load 3B.

first diode D1 and second diode D2 connected in series to first switch SW1 and second switch SW2 prevent electric current from flowing from first output part 53A through first branch path 41, switch unit 20, and second branch path 42 to second output part 53B even when first switch SW1 and second switch SW2 are simultaneously turned on. This configuration provides an advantageous effect that it is unnecessary to control first switch SW1 and second switch SW2 not to turn on the switches simultaneously, facilitating to control first switch SW1 and second switch SW2 by controller 12.

In accordance with the foregoing embodiment, charging-discharging circuit 11 is described in an embodiment in which charging-discharging circuit 11 boosts voltage Vin input from power supply 2 to first power feed path 31 so as to charge electricity storage unit 50, and steps down voltage V1 output from all-cell output part 54 of electricity storage unit 50 to supply the voltage to first load 3A. However, charging-discharging circuit 11 is not limited to this embodiment. The advantageous effects as described above are obtained in an embodiment in which charging-discharging circuit 11 steps down voltage Vin input from power supply 2 to first power feed path 31 and boosts voltage V1 output from all-cell output part 54 of electricity storage unit 50 to supply the voltage to first load 3A.

### (3) MODIFIED EXAMPLES

The foregoing exemplary embodiment is merely one of various embodiments of the present disclosure. The foregoing exemplary embodiment may be modified in various ways according to design and the like as long as the objects of the present disclosure are achieved.

Modified examples of the foregoing exemplary embodiment will be described below. The modified examples described below may be combined as appropriate. Backup power supply system 1 of the foregoing embodiment is referred to as the basic embodiment.

Backup power supply system 1 of the present disclosure includes a computer system. The computer system includes a processor and a memory as main hardware components. The processor executes programs recorded in the memory of the computer system to thereby implement the functions as backup power supply system 1 according to the present disclosure. The programs may be pre-recorded in the memory of the computer system, provided through an electronic telecommunication network, or recorded and provided in non-transitory recording media such as memory cards, optical disks, or hard disk drives that can be read by the computer system. The processor of the computer system may include one or a plurality of electronic circuits, including semiconductor integrated circuits (ICs) or large-scale integrated circuits (LSIs). The integrated circuits herein, such as ICs or LSIs, may be called differently depending on the degrees of integration, including integrated circuits referred to as system LSI, VLSI (Very Large Scale Integration), or ULSI (Ultra Large Scale Integration) circuits. Moreover, field-programmable gate arrays (FPGAs) programmed after fabrication of LSIs, or logic devices that allow reconfiguration of junction relationship inside LSIs or reconfiguration of circuit segmentation inside LSIs, may also be employed as the processor. The plurality of electronic circuits may be integrated on a single chip or may be distributed among a plurality of chips. The plurality of electronic circuits may be integrated into a single device or may be distributed among a plurality of devices. The computer system referred to herein may include a microcontroller including one or more processors and one or more memories. Accordingly, the microcontroller may also be configured by one or a plurality of electronic circuits including semiconductor integrated circuits or large-scale integrated circuits.

In the exemplary embodiment, the terms “higher than or equal to” and “greater than or equal to” used in comparison of two values, such as the measurement results of voltage, may be interchangeable with the terms “higher than” and “greater than”, respectively. That is, there is no technical difference between the term “greater than or equal to” and the term “greater than” as well as between the term “higher than or equal to” and the term “higher than” because it is possible to change whether the comparison of two values may include the case where the two values are equal as desired depending on the setting of reference values or the like. Likewise, the terms “lower than” and “less than” may be interchangeable with the terms “lower than or equal to” and “less than or equal to,” respectively.

### (3.1) Modified Example 1

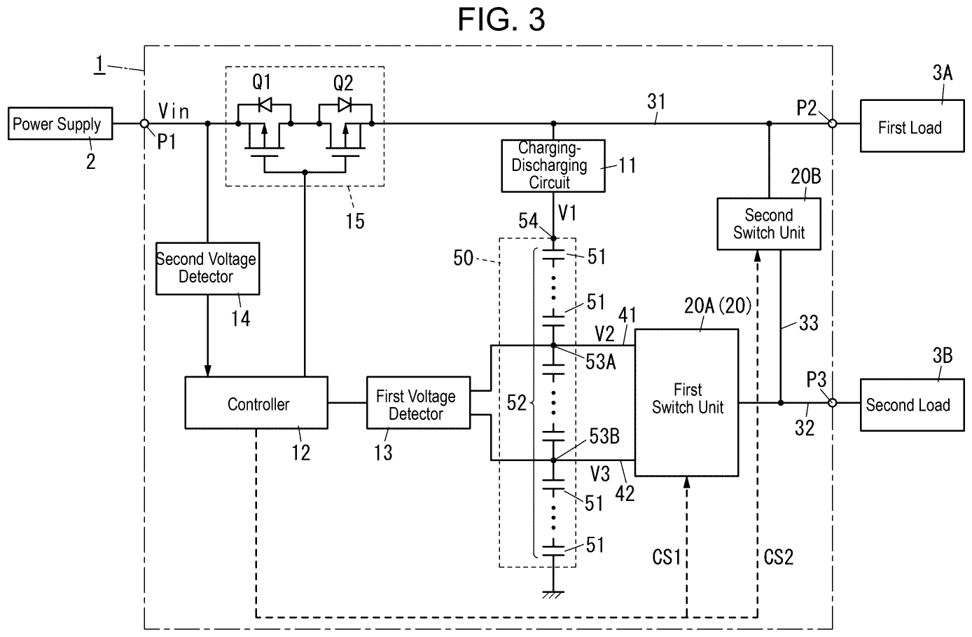

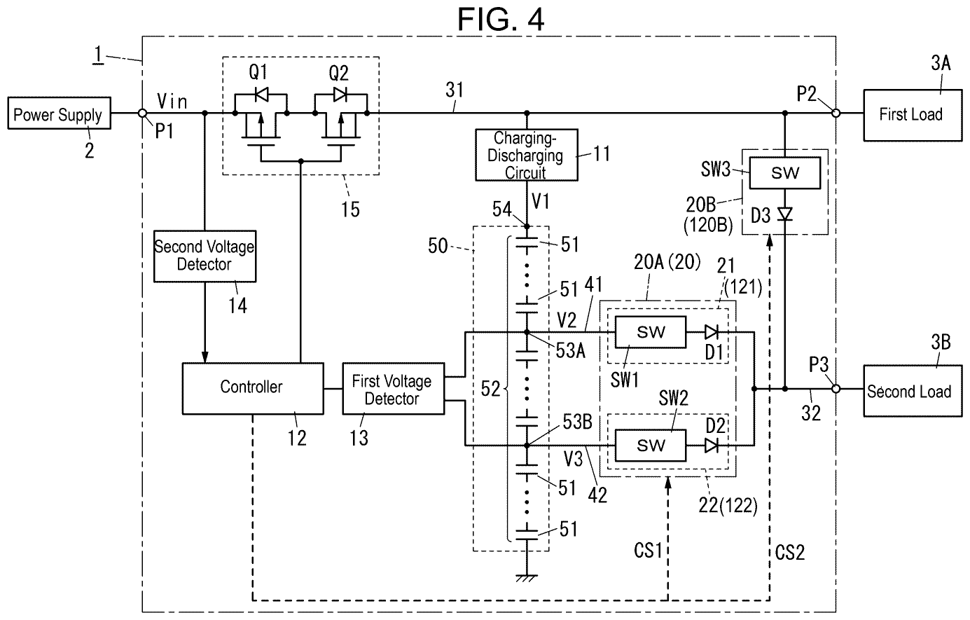

Backup power supply system 1 of modified example 1 will be described below with reference to FIGS. 3 and 4.

Backup power supply system 1 of modified example 1 is different from the foregoing embodiment in that second switch unit 20B is provided in addition to first switch unit 20A which is switch unit 20 described in the basic embodiment. Except for second switch unit 20B, backup power supply system 1 of this example is the same as backup power supply system 1 of the basic embodiment, and therefore, other components are denoted by the same reference numerals and their description will be omitted.

Backup power supply system 1 of modified example 1 includes first switch unit 20A and second switch unit 20B. First switch unit 20A is switch unit 20 described previously, and second switch unit 20B.

Second switch unit 20B is connected between first power feed path 31 and second power feed path 32 to establish a connected state or a disconnected state between first power feed path 31 and second power feed path 32. Specifically, second switch unit 20B is connected to first power feed path 31 and second power feed path 32 between first power feed path 31 and second power feed path 32. In this embodiment, second switch unit 20B is directly connected to first power feed path 31 and second power feed path 32.

When voltage V2 of first branch path 41 falls below the minimum operable voltage of second load 3B, controller 12 controls second switch unit 20B to establish the connected state between first power feed path 31 and second power feed path 32. On the other hand, when voltage V2 of first branch path 41 is higher than or equal to the minimum operable voltage of second load 3B, controller 12 controls second switch unit 20B to establish the disconnected state between first power feed path 31 and second power feed path 32.

Based on the detection result of first voltage detector 13 which is the voltage detector, controller 12 outputs, to second switch unit 20B, control signal CS1 for switching to the connected state or the disconnected state.

When voltage V2 of first branch path 41 falls below the minimum operable voltage of second load 3B, controller 12 controls second switch unit 20B to establish the connected state between first power feed path 31 and second power feed path 32. At this moment, electric power is supplied from charging-discharging circuit 11 operating in the discharge mode to second load 3B via first power feed path 31, second switch unit 20B, and second power feed path 32. Charging-discharging circuit 11 converts voltage V1 of electricity storage unit 50 to a voltage higher than or equal to the minimum operable voltage of first load 3A and second load 3B, and therefore applies a voltage higher than or equal to the minimum operable voltage to second load 3B, allowing second load 3B to operate properly.

FIG. 4 illustrates an example of a specific circuit of first switch unit 20A and second switch unit 20B.

First switch unit 20A includes series circuit 121 of first switch SW1 and first diode D1, and series circuit 122 of second switch SW2 and second diode D2. Series circuit 121 of first switch SW1 and first diode D1 is connected between third port P3 and first branch path 41. Series circuit 122 of second switch SW2 and second diode D2 is connected between third port P3 and second branch path 42. The configuration and operations of first switch unit 20A is the same as those of switch unit 20 described in the basic embodiment, and therefore, their description is omitted.

Second switch unit 20B includes series circuit 120B of third switch SW3 and third diode D3. Series circuit 120B is connected between first power feed path 31 and second power feed path 32. Specifically, series circuit 120B is connected to first power feed path 31 and second power feed path 32 between first power feed path 31 and second power feed path 32. In accordance with the embodiment, series circuit 120B is directly connected to first power feed path 31 and second power feed path 32. In series circuit 120B, third switch SW3 and third diode D3 are connected in series to each other.

Third switch SW3 is implemented by a semiconductor switch, such as a MOSFET. Third switch SW3 is controlled to be turned on or off by control signal CS2 input from controller 12. Third switch SW3 is not necessarily implemented by a MOSFET, but may be implemented by a semiconductor switch, such as an IGBT or a mechanical contactor, such as a relay.

A first end of third switch SW3 is connected to a node between main switch 15 and second port P2 in first power feed path 31. A second end of third switch SW3 is connected to the anode of third diode D3. The cathode of third diode D3 is connected to second power feed path 32. Thus, third diode D3 allows electric current to flow from first power feed path 31 toward second power feed path 32 and prevents electric current from flowing from second power feed path 32 toward first power feed path 31.

Next, an operation of backup power supply system 1 according to modified example 1 will be described.

In the non-failure state in which power supply 2 does not have a failure, voltage Vin higher than or equal to a threshold value is input from power supply 2 to first port P1. At this moment, controller 12 determines that power supply 2 is in the non-failure state based on the detection result of second voltage detector 14, and turns on MOSFETs Q1 and Q2 on to bring main switch 15 into the connected state. In addition, controller 12 outputs, to second switch unit 20B, control signal CS2 that turns third switch SW3 to be in the connected state to bring third switch SW3 into the connected state. When main switch 15 is brought into the connected state, voltage Vin input from power supply 2 to first port P1 is output from second port P2 to first load 3A, and first load 3A operates with by the electric power supplied from power supply 2. In addition, when third switch SW3 is brought into the connected state, voltage Vin input from power supply 2 to first port P1 is output to second load 3B connected to third port P3, so that second load 3B operates with by the electric power supplied from power supply 2.

Controller 12 causes charging-discharging circuit 11 to operate in a charge mode, and charging-discharging circuit 11 steps up voltage Vin input from power supply 2 to first power feed path 31 so as to charge electricity storage unit 50, and electricity storage unit 50 is charged to a voltage higher than voltage Vin of power supply 2. In the case that the number of electricity storage cells 51 that constitute electricity storage unit 50 is small, the voltage of electricity storage unit 50 may be lower than or equal to voltage Vin of power supply 2.

On the other hand, when power supply 2 turns to a failure state, voltage Vin input from power supply 2 to first port P1 becomes lower than the threshold value. At this moment, controller 12 determines that power supply 2 is in the failure state based on the detection result of second voltage detector 14, and turns off MOSFETs Q1 and Q2 to bring main switch 15 into the disconnected state.

In the failure state, controller 12 causes charging-discharging circuit 11 to operate in the discharge mode, and charging-discharging circuit 11 steps down or boosts voltage V1 output from all-cell output part 54 of electricity storage unit 50 to supply the stepped-down or boosted voltage to first load 3A.

In the failure state, controller 12 controls first switch unit 20A and second switch unit 20B based on the detection result of first voltage detector 13.

When voltage V3 of second branch path 42 is higher than or equal to the minimum operable voltage of second load 3B, controller 12 outputs, to first switch unit 20A, control signal CS1 that turns off first switch SW1 and turns on second switch SW2, and outputs, to switch unit 20B, control signal CS2 that turns off third switch SW3. At this moment, first switch SW1 is turned off, second switch SW2 is turned on, and third switch SW3 is turned off, so that electric power is supplied from second output part 53B of the k-th electricity storage cell 51 to second load 3B via second branch path 42, second switch SW2, second diode D2, and second power feed path 32.

When electric power is supplied from second output part 53B of electricity storage unit 50 to second load 3B, voltage V3 of second branch path 42 gradually decreases. Then, when voltage V3 of second branch path 42 reaches a voltage lower than the minimum operable voltage of second load 3B (the lower limit value of the operable voltage or the lower limit value of the operable voltage with a predetermined margin voltage added thereto), controller 12 outputs, to first switch unit 20A, control signal CS1 that instructs first switch unit 20A so as to turn on control first switch SW1 and turn off second switch SW2. In addition, controller 12 outputs, to second switch unit 20B, control signal CS2 that instructs second switch unit 20B to turn off third switch SW3. At this moment, first switch SW1 is turned on, second switch SW2 is turned off, and third switch SW3 is turned off, so that electric power is supplied from first output part 53A of the m-th electricity storage cell 51 to second load 3B via first branch path 41, first switch SW1, first diode D1, and second power feed path 32.

When electric power is supplied from first output part 53A of electricity storage unit 50 to second load 3B, voltage V2 of first branch path 41 gradually decreases. Then, when voltage V2 of first branch path 41 falls below the minimum operable voltage of second load 3B, controller 12 outputs, to first switch unit 20A, control signal CS1 that instructs first switch unit 20A to turn off control first switch SW1 and turn off second switch SW2. In addition, controller 12 outputs, to second switch unit 20B, control signal CS2 that instructs second switch unit 20B to turn on third switch SW3. At this moment, first switch SW1 is turned off, second switch SW2 is turned off, and third switch SW3 is turned on. Controller 12 causes charging-discharging circuit 11 to operate in the discharge mode, and causes charging-discharging circuit 11 to convert voltage V1 of all-cell output part 54 of electricity storage unit 50 to a voltage higher than or equal to the minimum operable voltage of second load 3B. At this moment, the output voltage of charging-discharging circuit 11 is applied to second load 3B via first power feed path 31, third switch SW3, third diode D3, and second power feed path 32, so that a voltage that is necessary for operation is applied to second load 3B.

Thus, in the failure state of power supply 2, first load 3A and second load 3B operate with the electric power supplied from electricity storage unit 50.

### (3.2) Modified Example 2

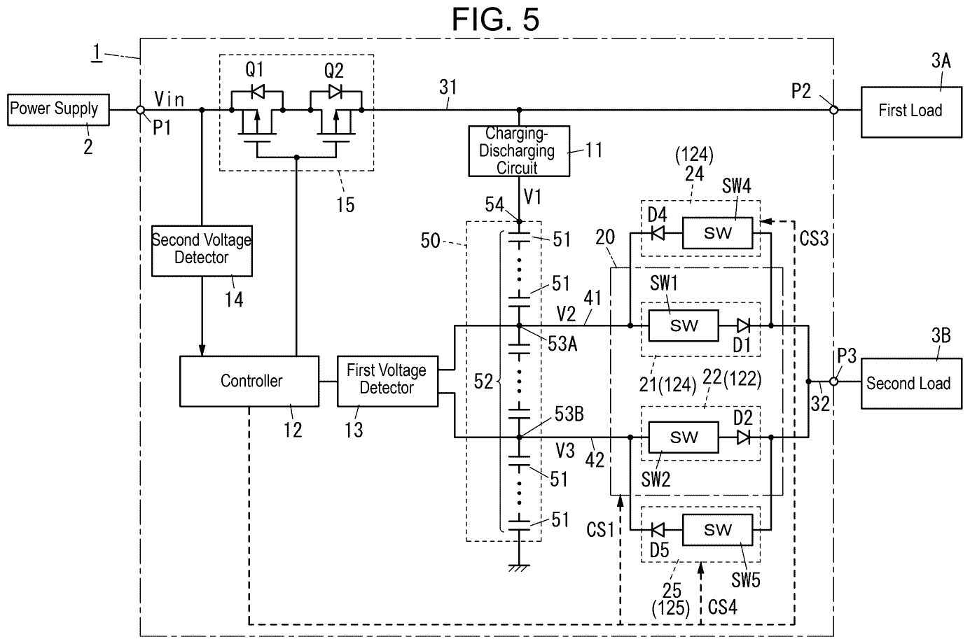

Backup power supply system 1 of modified example 2 will be described below with reference to FIG. 5.

Backup power supply system 1 of modified example 2 is different from the foregoing exemplary embodiment in that it further includes regenerative circuits 24 and 25. Other than regenerative circuits 24 and 25, backup power supply system 1 of this example is the same as backup power supply system 1 of the basic embodiment, and therefore, the same components are denoted by the same reference numerals and not further described.

Regenerative circuits 24 and 25 are circuits for causing regenerative current generated by second load 3B to flow from third port P3 to electricity storage unit 50. Regenerative circuits 24 and 25 are connected in parallel to switch unit 20.

Regenerative circuit 24 is connected between second power feed path 32 and first branch path 41. Regenerative circuit 24 is connected in parallel to first switch circuit 21. Specifically, regenerative circuit 24 is connected to second power feed path 32 and first branch path 41 between second power feed path 32 and first branch path 41. In accordance with the embodiment, regenerative circuit 24 is directly connected to second power feed path 32 and first branch path 41. Regenerative circuit 24 includes series circuit 124 of fourth switch SW4 and fourth diode D4. Series circuit 124 is connected between third port P3 and first branch path 41. In series circuit 124, fourth switch SW4 and fourth diode D4 are connected in series to each other. Specifically, series circuit 124 is connected to third port P3 and first branch path 41 between third port P3 and first branch path 41. In accordance with the embodiment, series circuit 124 is directly connected to third port P3 and first branch path 41.

Fourth switch SW4 is implemented by a semiconductor switch, such as a MOSFET. Fourth switch SW4 is not necessarily implemented by a MOSFET, but may be implemented by a semiconductor switch, such as an IGBT, or a mechanical contactor, such as a relay.

A first end of fourth switch SW4 is connected to second power feed path 32. A second end of fourth switch SW4 is connected to the anode of fourth diode D4. The cathode of fourth diode D4 is connected to first branch path 41.

Fourth switch SW4 is controlled to be turned on or off by control signal CS3 input from controller 12. Controller 12 turns on fourth switch SW4 when turning on first switch SW1. Controller 12 turns off fourth switch SW4 when turning off first switch SW1. When regenerative energy is generated by second load 3B, such as an electric motor, under the condition in which first switch SW1 is turned on and electric power is supplied from first branch path 41 via first switch SW1 to second load 3B, regenerative current flows to charge electricity storage unit 50 from second load 3B to electricity storage unit 50 via fourth switch SW4 and fourth diode D4.

Regenerative circuit 25 is connected between second power feed path 32 and second branch path 42. Regenerative circuit 25 is connected in parallel to second switch circuit 22. Specifically, regenerative circuit 25 is connected to second power feed path 32 and second branch path 42 between second power feed path 32 and second branch path 42. In accordance with the embodiment, regenerative circuit 25 is directly connected to second power feed path 32 and second branch path 42. Regenerative circuit 25 includes series circuit 125 of fifth switch SW5 and fifth diode D5. Series circuit 125 is connected between second power feed path 32 and second branch path 42. Specifically, series circuit 125 is connected to second power feed path 32 and second branch path 42 between second power feed path 32 and second branch path 42. In accordance with the embodiment, series circuit 125 is directly connected to second power feed path 32 and second branch path 42. In series circuit 125, fifth switch SW5 and fifth diode D5 are connected in series to each other.

Fifth switch SW5 is implemented by a semiconductor switch, such as a MOSFET. Fifth switch SW5 is not necessarily implemented by a MOSFET, but may be implemented by a semiconductor switch, such as an IGBT, or a mechanical contactor, such as a relay.

A first end of fifth switch SW5 is connected to second power feed path 32. A second end of fifth switch SW5 is connected to the anode of fifth diode D5. The cathode of fifth diode D5 is connected to second branch path 42.

Fifth switch SW5 is controlled to be turned on or off by control signal CS4 input from controller 12. Controller 12 turns on fifth switch SW5 when turning on second switch SW2. Controller 12 turns off fifth switch SW5 when turning off second switch SW2. When regenerative energy is generated by second load 3B, such as an electric motor, while second switch SW2 is turned on and electric power is supplied from second branch path 42 via second switch SW2 to second load 3B, regenerative current flows to charge electricity storage unit 50 from second load 3B to electricity storage unit 50 via fifth switch SW5 and fifth diode D5.

If backup power supply system 1 includes none of regenerative circuits 24 and 25, a high voltage may occur when regenerative energy is generated in second load 3B since there is no path that allows regenerative current to flow from second load 3B to electricity storage unit 50. Backup power supply system 1 of modified example 2 including regenerative circuits 24 and 25 allows regenerative current to flow from second load 3B to electricity storage unit 50 via regenerative circuits 24 and 25 when regenerative energy is generated in second load 3B. This configuration reduces the possibility of stress applied to circuit components due to the generation of high voltage.

Backup power supply system 1 of modified example 1 described above may include regenerative circuits 24 and 25 of modified example 2, which can obtain the same advantageous effects as obtained by the present modified example.

### (3.3) Other Modified Examples

In the basic embodiment and modified examples 1 described above, electricity storage unit 50 may include three or more output parts in addition to all-cell output part 54. Electricity storage unit 50 including three or more output parts provides three or more branch paths connected to the three or more output parts, respectively, and switch unit 20 may selectively connect one of the three or more branch paths to the second power feed path 32. Electricity storage unit 50 including three or more output parts allows any two of the three output parts to serve as the first output part and the second output part. Then, one of the two output parts with a higher potential as the first output part, and the branch path that is connected to the output part with a lower potential serves as the first branch path. On the other hand, one of the two output parts with a lower potential serves as the second output part, and the branch path that is connected to the output part with a lower potential serves as the second branch path.

In the basic embodiment and modified examples 1 and 2 described above, backup power supply system 1 may include plural third ports P3 configured to be connected to plural second loads, respectively. In the case that backup power supply system 1 includes plural third ports P3, backup power supply system 1 may include plural second power feed paths 32 connected to plural third ports P3, respectively, and include plural switch units 20 connected to plural second power feed paths 32, respectively. In this case, controller 12 may output, to each of the plurality of switch units 20, a control signal that instructs which of the first branch path and the second branch path is to be connected to the second power feed paths, based on the detection result of the voltage detector (first voltage detector 13) and based on the minimum operable voltage of the second loads 3B connected to the plural switch units 20, respectively.

In the basic embodiment and modified examples 1 and 2 described above, electric storage unit 50 may be a lithium ion capacitor (LIC) or a secondary battery, such as a lithium ion battery (LIB). In a lithium ion capacitor, the positive electrode is made of material similar to that of EDLC (such as activated carbon), and the negative electrode is made of a similar material to that of LIB (e.g., carbon material such as graphite).

Electric storage unit 50 is not necessarily an electric double layer capacitor, but may be, for example, an electrochemical device that has a structure as described below. The electrochemical device referred to herein includes a positive electrode member, a negative electrode member, and a non-aqueous electrolyte solution. The positive electrode member includes a positive electrode current collector, and a positive electrode material layer supported by the positive electrode current collector and containing a positive electrode active material. The positive electrode material layer contains a conductive polymer as a positive electrode active material that dopes and de-dopes anions (dopant). The negative electrode member includes a negative electrode material layer containing a negative electrode active material. An example of the negative electrode active material is a substance that undergoes oxidation-reduction reaction accompanying absorption and release of lithium ions. Specific examples include carbon materials, metallic compounds, alloys, ceramic materials, and the like. The non-aqueous electrolyte solution exhibits lithium-ion conductivity, for example. This type of non-aqueous electrolyte solution contains a lithium salt and a non-aqueous solution in which the lithium salt is dissolved. The electrochemical device with such a configuration has a higher energy density than electric double layer capacitors and the like.

The foregoing basic embodiment and modified examples 1 and 2 illustrate examples in which backup power supply system 1 is installed to an automobile. Backup power supply system 1 may be installed to other movable bodies, such as airplanes, ships, or trains. In addition, backup power supply system 1 is not necessarily installed to movable bodies, but may be installed and used in, e.g., various facilities.

### Conclusion

From the exemplary embodiments described thus far, the disclosure includes following aspects.

According to a first aspect, a backup power supply system (1) includes a first power feed path (31), a third port (P3), an electricity storage unit (50), a charging-discharging circuit (11), a second power feed path (32), a first branch path (41), a second branch path (42), a controller (12), a switch unit (20), and a voltage detector (13). The first power feed path (31) connects the first port (P1) to the second port (P2). The first port (P1) is configured to be connected to a power supply (2). The second port (P2) is configured to be connected to a first load (3A). The third port (P3) is configured to be connected to a second load (3B). The electricity storage unit (50) includes a cell assembly (52) including n electricity storage cells (51) connected in series to one another where n is an integer greater than or equal to 3. The charging-discharging circuit (11) is configured to charge the electricity storage unit (50) with electric power supplied from the first power feed path (31) and output electric power discharged from the electricity storage unit (50) to the first power feed path (31). The second power feed path (32) is connected to the third port (P3). The first branch path (41) is connected to a first output part (53A) which is an output part of a m-th electricity storage cell (51) out of the n electricity storage cells (51) of the cell assembly (52) where m is a positive integer less than or equal to n. The second branch path (42) is connected to the second output part (53B) which is an output part of the k-th electricity storage cell (51) out of the n electricity storage cells (51) of the cell assembly (52) where k is a positive integer less than m. The switch unit (20) is configured to selectively connect one of the first branch path (41) and the second branch path (42) to the second power feed path (32) according to a control signal (CS1) input from the controller (12). The voltage detector (13) is configured to detect a voltage value of a voltage of the first branch path (41) and a voltage value of a voltage of the second branch path (42). The controller (12) is configured to output, to the first switch unit (20), the control signal (CS1) that instructs, based on the detection result of the first voltage detector (13), which one of the first branch path (41) and the second branch path (42) is to be connected to the second power feed path (32).

According to this aspect, as electric power is supplied from the electricity storage unit (50) to the second load (3B), the voltage values of the voltage of the first branch path (41) and the voltage of the second branch path (42) decrease. But, since the controller (12) connects the first branch path (41) or the second branch path (42) to the second power feed path (32) according to the detection result of the voltage detector (13), it is possible to reduce the possibility that the voltage applied to the second load (3B) falls below the minimum operable voltage of the second load (3B).

In the backup power supply system (1) according to a second aspect, which may be implemented in conjunction with the first aspect, the first switch unit (20) includes a series circuit of a first switch (SW1) and a first diode (D1), and another series circuit of a second switch (SW2) and a second diode (D2). The series circuit including the first switch (SW1) and the first diode (D1) is connected between the third port (P3) and the first branch path (41). The another series circuit including the second switch (SW2) and the second diode (D2) is connected between the third port (P3) and the second branch path (42).

According to this aspect, it is possible to reduce the possibility that the voltage applied to the second load (3B) falls below the minimum operable voltage of the second load (3B).

The backup power supply system (1) according to a third aspect, which may be implemented in conjunction with the first or second aspect, further includes a regenerative circuit (24, 25) allowing a regenerative current generated by the second load (3B) to flow from the third port (P3) to the electricity storage unit (50). The regenerative circuit (24, 25) is connected in parallel to the first switch unit (20).

According to this aspect, the regenerative current generated by the second load (3B) is regenerated in the electricity storage unit (50). Therefore, it is possible to reduce the possibility of high voltage that occurs when regenerative energy is generated in the second load (3B) as in the case where the regenerative circuit (24, 25) is not provided.

The backup power supply system (1) according to a fourth aspect, which may be implemented in conjunction with the first aspect, further includes a second switch unit (20B) connected between the first power feed path (31) and the second power feed path (32). The second switch unit (20B) is configured to establish a connected state or a disconnected state between the first power feed path (31) and the second power feed path (32). When the voltage of the first branch path (41) is lower than the minimum operable voltage of the second load (3B), the controller (12) is configured to control second switch unit (20B) to establish the connected state between the first power feed path (31) and the second power feed path (32).

According to this aspect, when the voltage of the first branch path (41) is lower than the minimum operable voltage of the second load (3B), the second switch unit (20B) is controlled so as to establish the connected state between the first power feed path (31) and the second power feed path (32). As a result, it is possible to apply a voltage that is required to activate the second load (3B) from the charging-discharging circuit (11).

In the backup power supply system (1) according to a fifth aspect, which may be implemented in conjunction with the fourth aspect, the first switch unit (20) includes a series circuit of a first switch (SW1) and a first diode (D1), and another series circuit of a second switch (SW2) and a second diode (D2). The series circuit including the first switch (SW1) and the first diode (D1) is connected between the third port (P3) and the first branch path (41). The another series circuit of the second switch (SW2) and the second diode (D2) is connected between the third port (P3) and the second branch path (42).

According to this aspect, it is possible to reduce the possibility that the voltage applied to the second load (3B) falls below the minimum operable voltage of the second load (3B).

In the backup power supply system (1) according to a sixth aspect, which may be implemented in conjunction with the fourth or fifth aspect, the second switch unit (20B) includes a series circuit of a third switch (SW3) and a third diode (D3). The series circuit is connected between the first power feed path (31) and the second power feed path (32).

According to this aspect, when the voltage of the first branch path (41) is lower than the minimum operable voltage of the second load (3B), the third switch (SW3) is turned on. As a result, it is possible to apply a voltage that is required to activate the second load (3B) from the charging-discharging circuit (11).

The backup power supply system (1) according to a seventh aspect further includes, in any one of the fourth to sixth aspects, a regenerative circuit (24, 25) allowing a regenerative current generated by the second load (3B) to flow from the third port (P3) to the electricity storage unit (50). The regenerative circuit (24, 25) is connected in parallel to the first switch unit (20).

According to this aspect, the regenerative current generated by the second load (3B) can be regenerated in the electricity storage unit (50). Therefore, it is possible to reduce the possibility of a high voltage that occurs when regenerative energy is generated in the second load (3B) as in the case where the regenerative circuit (24, 25) is not provided.

The configurations according to the second to seventh aspects are not essential to the backup power supply system (1) and may therefore be omitted as appropriate.

### REFERENCE MARKS IN THE DRAWINGS

1 backup power supply system
2 power supply
3A first load
3B second load
11 charging-discharging circuit
12 controller
13 first voltage detector (voltage detector)
20 switch unit
20A first switch unit
20B second switch unit
24, 25 regenerative circuit
31 first power feed path
32 second power feed path
41 first branch path
42 second branch path
50 electricity storage unit
51 electricity storage cell
52 cell assembly
53A first output part
53B second output part
CS1 control signal
D1 first diode
D2 second diode
D3 third diode
P1 first port
P2 second port
P3 third port
SW1 first switch
SW2 second switch
SW3 third switch

1. A backup power supply system comprising:
a first power feed path connecting a first port to a second port, the first port being configured to be connected to a power supply, the second port being configured to be connected to a first load;
a third port configured to be connected to a second load;
an electricity storage unit including a cell assembly including n electricity storage cells connected in series to one another where n is an integer greater than or equal to 3;
a charging-discharging circuit configured to charge the electricity storage unit with electric power supplied through the first power feed path and output electric power discharged from the electricity storage unit to the first power feed path;
a second power feed path connected to the third port;
a first branch path connected to a first output part, the first output part being an output part of an m-th electricity storage cell out of the n electricity storage cells of the cell assembly where m is a positive integer less than or equal to n;
a second branch path connected to a second output part, the second output part being an output part of a k-th electricity storage cell out of the n electricity storage cells of the cell assembly where k is a positive integer less than m;
a first switch unit configured to selectively connect one of the first branch path and the second branch path to the second power feed path;
a voltage detector configured to detect a voltage value of a voltage of the first branch path and a voltage value of a voltage of the second branch path; and
a controller configured to output a control signal to the first switch unit based on a detection result of the voltage detector, the control signal instructing the first switch unit which one of the first branch path and the second branch path is connected to the second branch path.

2. The backup power supply system according to claim 1, wherein the first switch unit includes:
a series circuit connected between the third port and the first branch path and including a first switch and a first diode; and
another series circuit connected between the third port and the second branch path and including a second switch and a second diode.

3. The backup power supply system according to claim 1, further comprising
a regenerative circuit allowing a regenerative current generated by the second load to flow from the third port to the electricity storage unit, wherein
the regenerative circuit is connected in parallel to the first switch unit.

4. The backup power supply system according to claim 1, further comprising
a second switch unit connected between the first power feed path and the second power feed path, the second switch unit being configured to establish a connected state or a disconnected state between the first power feed path and the second power feed path, wherein
when a voltage of the first branch path is lower than a minimum operable voltage of the second load, the controller is configured to control the second switch unit to establish the connected state between the first power feed path and the second power feed path.

5. The backup power supply system according to claim 4, wherein the first switch unit includes:
a series circuit connected between the third port and the first branch path, the series circuit including a first switch and a first diode; and
another series circuit connected between the third port and the second branch path, the another series circuit including a second switch and a second diode.

6. The backup power supply system according to claim 4, wherein the second switch unit includes a series circuit connected between the first power feed path and the second power feed path and including a third switch and a third diode.

7. The backup power supply system according to claim 4, further comprising
a regenerative circuit allowing a regenerative current generated by the second load to flow from the third port to the electricity storage unit, wherein
the regenerative circuit is connected in parallel to the first switch unit.
